(19) United States
(12) Patent Application Publication
(10) Pub. No.: US 2009/0324223 A1
(43) Pub. Date: Dec. 31, 2009

(54) System, method and apparatus for channel estimation with dual polarization training symbols for coherent optical OFDM

(76) Inventor: Xiang Liu, Marlboro, NJ (US)

Correspondence Address: Docket Administrator (Room 2F-192);Lucent Technologies, Inc., 600 Mountain Avenue, Murray Hill, NJ, 07974-0636, US

(21) Appl. No.: 12/215,741

(22) Filed: Jun. 30, 2008

(51) Int. Cl. H04J 14/06

(52) U.S. Cl. 398/65

(57) ABSTRACT

System, apparatus and method of optical communication are provided for performing channel estimation for an optical OFDM system by utilizing correlated dual-polarization training symbols (CDPTS) to offer high system tolerance to fiber nonlinear effects such as cross-phase modulation (XPM) among wavelength-division multiplexed (WDM) channels. An exemplary method includes receiving a pair of dual-polarization or polarization-multiplexed training symbols in an optical polarization-division multiplexed (PDM) orthogonal frequency-division multiplexed (OFDM) signal, and performing channel estimation to obtain an estimated channel matrix for at least a first of a plurality of subcarriers of the PDM-OFDM signal. Channel compensation is performed based on the estimated channel matrix for at least the first subcarrier of the OFDM signal and symbols then decoded.

### FIELD OF THE INVENTION

The invention relates to optical transmission systems, and, in particular, to systems, apparatuses and techniques for coherent optical orthogonal frequency-division multiplexing (CO-OFDM) systems that employ channel estimation.

### BACKGROUND INFORMATION

Chromatic dispersion (CD) is a deterministic distortion given by the design of the optical fiber. It leads to a frequency dependence of the optical phase and its effect on transmitted signal scales quadratically with the bandwidth consumption or equivalently the data rate. Therefore the CD tolerances are reduced to 1/16, if the data rate of a signal is increased by a factor of 4. Up to 2.5 Gb/s data rate optical data transmission is feasible without any compensation of CD even at long haul distances. At 10 Gb/s, the consideration of chromatic dispersion becomes necessary, and dispersion compensating fibers (DCF) are often used. At 40 Gb/s and beyond, even after the application of DCF the residual CD may still be too large.

Polarization-mode dispersion (PMD) is a stochastic characteristic of optical fiber due to imperfections in production and installation. Pre-1990 fibers exhibit high PMD values well above 0.1 ps/√km which are border line even for 10 Gb/s. Newer fibers have a PMD lower than 0.1 ps/√km, but other optical components in a fiber link such as reconfigurable add/drop multiplexers (ROADMs) may cause substantial PMD. If 40 Gb/s systems are to be operated over the older fiber links or new fiber links with many ROADMs, PMD may become a significant detriment. PMD can be compensated by optical elements with an inverse transmission characteristics to the fiber. However, due to the statistical nature of PMD with fast variation speeds up to the few kHz range, the realization of optical PMD compensators is challenging. With increases in channel data rate, optical signal is more and more limited by the transmission impairments in optical fiber such as CD and PMD.

Cross phase modulation (XPM) is a nonlinear effect in which the optical intensity of one lightwave influences the optical phase of another. XPM usually causes a change in the optical phase of a lightwave through the interaction with another lightwave in a nonlinear medium, specifically a Kerr medium. In optical fiber communications, XPM in fibers can lead to problems with cross talk among wavelength-division multiplexed (WDM) channels.

Orthogonal frequency-division multiplexing (OFDM) is a widely used digital modulation/multiplexing technique. Coherent optical orthogonal frequency-division multiplexing (CO-OFDM) is being considered as a promising technology for future high-speed (e.g., 100-Gb/s) optical transport systems. In long-haul optical fiber transmission where polarization rotation and PMD occur, it is needed to estimate the channel response that is usually in the form of a 2×2 matrix in order to recover the originally transmitted OFDM signal. For easy channel estimation, a pair of singly polarized training symbols whose polarizations are orthogonal to each other is typically used. However, this makes the optical power of each of the training symbols to be 50% lower than that of a polarization-division multiplexed (PDM) OFDM payload symbol that uses two orthogonal polarizations of a wavelength channel to carry information. Due to the power difference, large XPM effect occurs in WDM transmission of such PDM-OFDM wavelength channels, thereby degrading the transmission performance of the PDM-OFDM channels.

### SUMMARY OF THE INFORMATION

In CO-OFDM, accurate and efficient channel estimation is desirable in order to compensate for transmission impairments such as CD and PMD. System, method and apparatus embodiments of the invention are provided that efficiently perform channel estimation for a CO-OFDM link suffering from noise and transmission impairments and provide high system tolerance to the XPM effect among WDM channels. An exemplary method of optical communication that includes channel estimation utilizing a pair of correlated dual-polarization training symbols (CDPTS) is proposed.

The exemplary method includes receiving a pair of dual-polarization or polarization-multiplexed training symbols in an optical polarization-division multiplexed (PDM) orthogonal frequency-division multiplexed (OFDM) signal and performing channel estimation to obtain an estimated channel matrix for at least a first of a plurality of subcarriers of the PDM-OFDM signal. The OFDM payload symbols and training symbols are polarization-division multiplexed (PDM) so that information is carried in two orthogonal polarization states of an optical wave. The estimated channel matrix may be a 2×2 matrix with complex numbers as elements.

The method may further include performing channel compensation based on the estimated channel matrix for the at least first subcarrier of the PDM-OFDM signal and decoding a symbol for at least the first subcarrier based on the estimated channel matrix for the at least first subcarrier. For example, the estimated channel matrix can be inverted and the inverted matrix multiplied with the received subcarrier vector for at least the first subcarrier of the PDM-OFDM signal. An estimated channel matrix may also be determined for each subcarrier and used for compensation and/or decoding each subcarrier of the OFDM signal. Alternatively, an estimated channel matrix for each of the plurality of subcarriers of the PDM-OFDM signal can be obtained via channel estimation and channel compensation performed on a per subcarrier basis based on a corresponding estimated channel matrix.

The pair of dual-polarization training symbols can be received periodically in the OFDM signal in order to update the estimated channel matrices and may or may not be the same pair of training symbols in each iteration of the method. The power of each dual-polarization training symbol is substantially the same as the power of a PDM-OFDM payload symbol such that the OFMD symbol sequence has a substantially constant-power format. The pair of dual-polarization training symbols may be correlated. In one embodiment, the pair of dual-polarization training symbols are correlated and, optical fields along one polarization of the pair of training symbols are the same and the optical fields along the other polarization of the pair of training symbols are opposite to each other or differ only by sign.

The correlated pair of dual-polarization training symbols may be jointly processed in the channel estimation process. The optical field of each of two polarizations of each of the training symbols has a real and an imaginary component. Preferably, the optical power waveform of each of two polarizations of each of the dual-polarization training symbols has a low peak-to-average-power ratio (PAPR).

Estimation of the optical channel includes determining a functional relationship between the received pair of dual-polarization training symbols and a transmitted pair of dual-polarization training symbols on a per-subcarrier basis.

Embodiments of an optical communication system for implementing disclosed system include an OFDM receiver that has a receiver front-end for receiving a pair of dual-polarization or polarization-multiplexed training symbols in a PDM-OFDM symbol sequence and a channel estimation module for performing channel estimation based on the pair of training symbols to obtain an estimated channel matrix for at least a first of a plurality of subcarriers of the PDM-OFDM signal. The receiver may further include a channel compensation module for performing channel compensation based on the estimated channel matrix and a decoding module for decoding a symbol that has passed though the channel compensation module.

The system may further include a polarization-division multiplexed (PDM) orthogonal frequency-division multiplexed (OFDM) transmitter having a training symbol insertion module for inserting a pair of dual-polarization or polarization-multiplexed training symbols into the OFDM symbol sequence.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein

FIG. 1 is a schematic diagram of an exemplary optical transmission system that employs channel estimation based on a pair of correlated dual-polarization training symbols (CDPTS); and

FIG. 2 is a flow chart illustrating a method in a compensation module of an polarization-division multiplexed (PDM) orthogonal frequency-division multiplexed (OFDM) receiver for processing a signal according to a preferred embodiment of the invention.

### DETAILED DESCRIPTION

Various example embodiments will now be described more fully with reference to the accompanying figures in which like numbers refer to like elements throughout the description of the figures.

Specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, etc. may be used herein to describe various elements, these elements should not be limited by these term since such terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items, and the singular forms “a” , “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

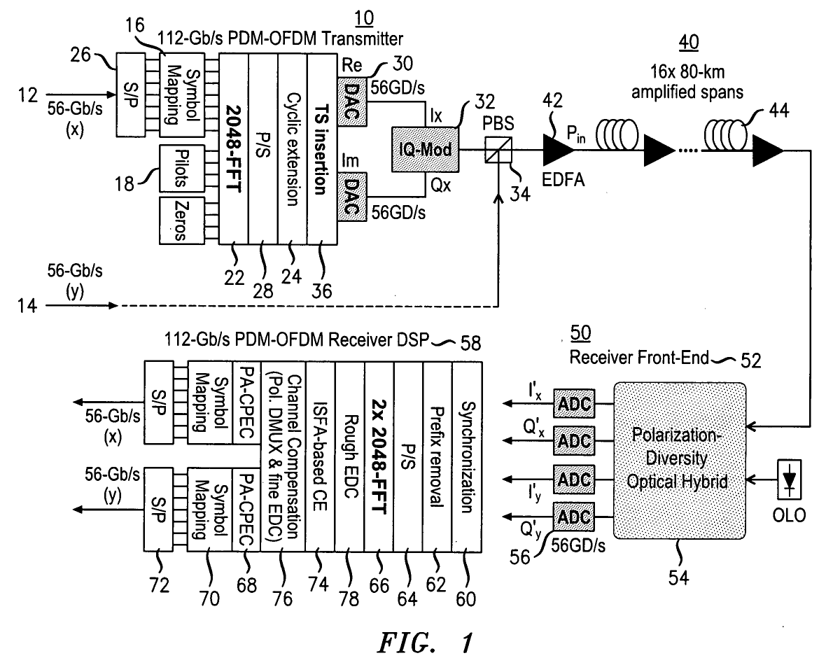

FIG. 1 is schematic diagram of an exemplary optical transmission system that employs correlated dual-polarization training symbols (CDPTS) based channel estimation. A 112-Gb/s PDM-OFDM transmitter 10 is connected via an optically amplified transmission link 20 to a 112-Gb/s PDM-OFDM receiver setup. Other data rate signals can be handled in a similar manner.

At the transmitter 10, the original 112-Gb/s data (not shown) are first divided into x- and y-polarization branches 12 and 14 each of which is mapped by symbol mapping module 16 onto frequency subcarriers with modulation, which, together with pilot subcarriers provided by pilot module 18, are transferred to the time domain by an Inverse Fast Fourier Transform (IFFT) supplied by IFFT module 20. For example, each polarization branch 12 or 14 may be mapped onto 1280 frequency subcarriers with quadrature phase shift keying (QPSK) modulation, which, together with 16 pilot subcarriers, are transferred to the time domain by an IFFT of size 2048 with a filling ratio of ˜63%. The 16 pilot subcarriers are preferably distributed uniformly in the frequency domain.

A cyclic prefix may be inserted by cyclic extension module 24 to accommodate inter-symbol interference which may be caused by CD and PMD in the optical transmission link 20. For example, a cyclic prefix of length 512 can be used to accommodate dispersion of up to ˜20,000 ps/nm, resulting in an OFDM symbol size of 2560.

The IFFT algorithm is organized on a symbol basis requiring a parallelization via a serial-to-parallel module 26 of input data before application of the algorithm and a serialization via parallel-to-serial module 28 afterwards. After parallelization of data in the transmitter a coder is required transferring a binary on-off coding into, for example, a four level phase modulation signal with the amplitudes [−1, +, −j, +j].

The superposition of multiple frequency carriers leads to an analog signal in the time domain. Hence a digital-to-analog converter (DAC) 30 is required after serialization in the transmitter and opposite analog-to-digital converter (ADC) in the receiver in front of the pure digital signal processing. The DAC operates at a given sampling rate. For example, after the time-domain samples corresponding to the real and imaginary parts of one polarization component of the PDM-OFDM signal are serialized they may be converted by two 56-GS/s DACs.

The two analog waveforms converted by the two DACs are used to drive an I/Q modulator 32 to form one polarization component of the PDM-OFDM signal, which is then combined with the other polarization component of the PDM-OFDM signal generated similarly (not shown) by a polarization beam splitter (PBS) 34 to form the original PDM-OFDM signal. The transmitter also includes a training symbol insertion module 36 for inserting training symbols for use in channel estimation. The training symbols are a pair of dual-polarization or polarization multiplexed training symbols so that the overall power of each of the training symbols is the same as that of a PDM-OFDM payload symbol, and the overall OFDM symbol sequence is of a constant power format. A non-uniform power waveform of a wavelength channel causes large XPM penalty to other WDM channels, thus use of single-polarization training symbols instead of dual-polarization training symbols causes detrimental effects on transmission performance.

The orthogonal frequency-division multiplexed (OFDM) signal is carried via an optically amplified transmission link 40 to a 112-Gb/s PDM-OFDM receiver 50. The optical link includes and number of Erbium doped fiber amplifiers (EDFA) 42 for amplifying the signal during its transport over a number of fiber spans 44. The optical link suffers from fiber nonlinearity, CD and PMD.

At the receiver 50, digital coherent detection with polarization diversity is used to sample the fields of two orthogonal components of the received optical signal at the receiver front end 52. Thus, the receiver front end includes Polarization Diversity Optical Hybrid 54 and analog-to-digital converters (ADC) 56. The ADC operates at a predetermined sampling rate, which can be the same as that of the DAC.

Symbol synchronization is then performed, and training symbols are extracted for channel estimation that obtains the effects PMD and CD on each OFDM subcarrier at the receiver digital signal processor (DSP) 58. Thus, DSP includes modules for symbol synchronization 60, prefix removal 62, parallel-to-serial conversion 64, Fast Fourier Transform (FFT) 66, pilot-assisted common phase error compensation (PA-CPEC) 68, symbol mapping 70, and serial-to-parallel conversion 72.

The DSP also includes modules for correlated dual-polarization training symbol (CDPTS) based channel estimation (CDPTS-based CE) 74 and channel compensation 76. The DSP may also include electronic dispersion compensation (EDC) module 78 which performs compensation before performing the channel estimation and compensation.

Descriptions on the channel estimation and compensation method follow below. The bandwidth of a single subcarrier is determined by the laser linewidth, which is usually so small that over the bandwidth, the frequency-domain transfer function of the transmission channel can be regarded as flat or constant. The combined effect of PMD and CD on a PDM-OFDM signal can be described as

$$[ \begin{matrix}{s}_{x}^{′} ( k ) \\ {s}_{y}^{′} ( k )\end{matrix} ] = [ \begin{matrix}a ( k ) & b ( k ) \\ c ( k ) & d ( k )\end{matrix} ] [ \begin{matrix}{s}_{x} ( k ) \\ {s}_{y} ( k )\end{matrix} ] , \qquad ( 1 )$$

where the 2×1 vectors on the left hand side and the right hand side of the equation are the received and the transmitted OFDM signal for the k-th subcarrier, and the 2×2 matrix is the channel matrix or Jones matrix representing the effect of CD and PMD. The channel matrix may also contain the effect of polarization-dependent loss (PDL).

The training symbols are polarization-multiplexed such that the overall power of each of the training symbols is the same as that of a PDM-OFDM payload symbol and the overall OFDM symbol sequence is of a constant power format. To simply the channel estimation process, the dual-polarization training symbols, denoted as t₁ and t₂, can be correlated in the following way

$${t}_{1} = [ \begin{matrix}{t}_{x} \\ {t}_{y}\end{matrix} ] , \\ {t}_{2} = [ \begin{matrix}{t}_{x} \\ - {t}_{y}\end{matrix} ] , \qquad ( 2 )$$

where tₓ and t_{y} are two known single-polarization symbols, preferably with low peak-to-average-power-ratio (PAPR). Note that the pair of training symbols can be periodically inserted into the OFDM symbol sequence in order to capture dynamic channel behaviors. However, periodically does not connote any fixed time duration between insertion of the training symbols; the training symbols can be inserted from time to time. The same training symbol may be inserted each time or the training symbol can be changed after a predetermined number of insertions or after each insertion if proper notification is given.

Assuming that the two dual-polarization training symbols experience the same channel effect which is usually true when they are close to each other in the time domain, the received training symbols can be written as

$$\begin{matrix}{t}_{1}^{′} ( k ) = [ \begin{matrix}{t}_{1 x}^{′} ( k ) \\ {t}_{1 y}^{′} ( k )\end{matrix} ] = [ \begin{matrix}a ( k ) {t}_{x} ( k ) + b ( k ) {t}_{y} ( k ) \\ c ( k ) {t}_{x} ( k ) + d ( k ) {t}_{y} ( k )\end{matrix} ] , & ( 3 ) \\ {t}_{2}^{′} ( k ) = [ \begin{matrix}{t}_{2 x}^{′} ( k ) \\ {t}_{2 y}^{′} ( k )\end{matrix} ] = [ \begin{matrix}a ( k ) {t}_{x} ( k ) - b ( k ) {t}_{y} ( k ) \\ c ( k ) {t}_{x} ( k ) - d ( k ) {t}_{y} ( k )\end{matrix} ] . & ( 4 )\end{matrix}$$

The channel matrix can then be obtained as

$$[ \begin{matrix}a ( k ) & b ( k ) \\ c ( k ) & d ( k )\end{matrix} ] = [ \begin{matrix}\frac{{t}_{1 x}^{′} ( k ) + {t}_{2 x}^{′} ( k )}{2 {t}_{x} ( k )} & \frac{{t}_{1 x}^{′} ( k ) - {t}_{2 x}^{′} ( k )}{2 {t}_{y} ( k )} \\ \frac{{t}_{1 y}^{′} ( k ) + {t}_{2 y}^{′} ( k )}{2 {t}_{x} ( k )} & \frac{{t}_{1 y}^{′} ( k ) - {t}_{2 y}^{′} ( k )}{2 {t}_{y} ( k )}\end{matrix} ] . \qquad ( 5 )$$

It is clear from above that the use of the CDPTS offers the benefit of simple channel estimation. The computation effort needed for the CDPTS based channel estimation is essentially the same as that based on a pair of singly-polarized training symbols, but the CDPTS based channel estimation additionally offers reduced XPM effect that detrimentally affects the performances of other WDM channels.

The channel matrix estimated in this fashion is then used to perform channel compensation. The obtained channel matrices at different subcarrier frequencies are inverted and applied to the subcarriers in the payload symbols for channel compensation that realizes polarization de-multiplexing, and compensation of PMD, CD, and/or PDL.

The average phase of the pilots of each OFDM symbol is used for pilot-assisted common phase error compensation (PA-CPEC). The other signal processes needed to recover the original data are performed by other modules identified above and the transmitted signal is recovered for each subcarrier.

In addition, to save computational efforts, the channel estimation method described may update the channel information at a speed that is much slower than the real-time data speed, but much faster than the speed of channel physical changes, which is usually in the order kHz.

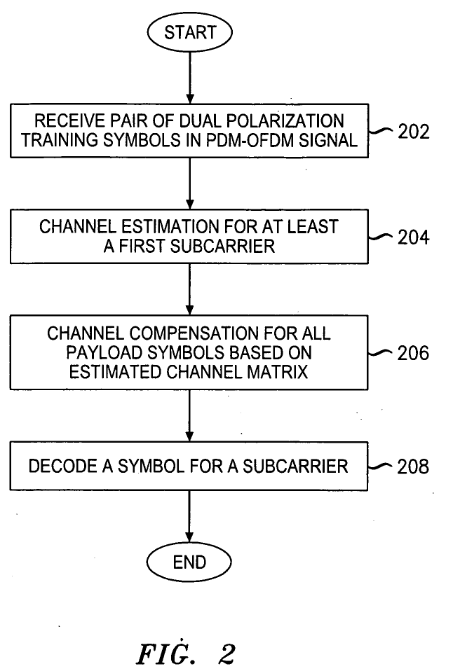

FIG. 2 is a flow chart illustrating an exemplary method in an orthogonal frequency-division multiplexed (OFDM) receiver for processing a signal according to an embodiment of correlated dual-polarization training symbols (CDPTS) based channel estimation. Referring now to FIG. 2, a pair of dual-polarization or polarization-multiplexed training symbols in an optical polarization-division multiplexed (PDM) orthogonal frequency-division multiplexed (OFDM) signal are received (Step 202). The OFDM signal and training symbols are polarization-division multiplexed (PDM) so that information is carried in two orthogonal polarization states of an optical wave.

The pair of training symbols can be received periodically in the PDM-OFDM signal. The pair of training symbols may or may not be the same pair of training symbols for each reception of training symbols. If training symbols are changed, the receiver must be appropriately notified.

The power of each training symbol preferably is substantially the same as the power of a PDM-OFDM payload symbol such that the OFMD symbol sequence has a substantially constant-power format. The pair of training symbols may also be correlated. In one embodiment, the pair of training symbols are correlated and, optical fields along one polarization of the pair of training symbols are the same and the optical fields along the other polarization of the pair of training symbols are opposite to each other or differ only by sign.

The correlated pair of training symbols may also be jointly processed in the CDPTS based channel estimation process. For example, the correlated training symbols may be jointly processed according to Equation (5).

At Step 204, channel estimation is performing to obtain estimated channel matrix for at least a first of a plurality of subcarriers of the PDM-OFDM signal (Step 204). Estimation of the channel may include determining a functional relationship between the received pair of training symbols and a transmitted pair of training symbols on a per-subcarrier basis. Channel estimation relates the received pair of training symbols to an originally transmitted pair of training symbols. The estimated channel matrix may be 2×2 matrix with complex numbers as elements. In the preferred embodiment, channel estimation is accomplished on per-subcarrier basis; an estimated channel matrix may also be determined for each subcarrier. Such channel estimation may occur periodically, each time a pair of training symbols is received in order to update the estimated channel matrices, following which the process flow may go back to Step 202.

The method may include performing channel compensation based on the estimated channel matrix for the first subcarrier of the PDM-OFDM signal (Step 206). For example, the estimated channel matrix can be inverted and the inverted matrix multiplied with the received subcarrier vector for at least the first subcarrier of the OFDM signal to perform channel compensation. Further, the estimated channel matrix for each subcarrier of the PDM-OFDM signal can be obtained via channel estimation and channel compensation performed on a per subcarrier basis based on a corresponding estimated channel matrix.

The method may further include decoding a symbol for the first subcarrier based on the estimated channel matrix. (Step 208). An estimated channel matrix may also be determined for each subcarrier and used for compensation/decoding the PDM-OFDM signal of each subcarrier. Steps 206 and 208 are used to process all the payload symbols, while steps 202-204 only need to process the occasional training symbols at a much lower update speed

Optical dispersion compensation or electronic dispersion compensation (EDC) of the received training symbols and/or the received OFDM signal may also be performed in combination with the CDPTS channel estimation. EDC is performed prior to the CDPTS channel estimation of the estimated channel matrix and may be based on a guess of the dispersion experienced by the PDM-OFDM signal. Optical dispersion compensation or electronic dispersion compensation (EDC) of the received training symbols and/or the received OFDM signal may need to be performed before the ISFA procedure.

All of the functions described above are readily carried out by special or general purpose digital information processing devices acting under appropriate instructions embodied, e.g., in software, firmware, or hardware programming.

What is claimed is:

1. A method of optical communication comprising:
receiving a pair of dual-polarization or polarization-multiplexed training symbols in an optical polarization-division multiplexed (PDM) orthogonal frequency-division multiplexed (OFDM) signal;
performing channel estimation to obtain an estimated channel matrix for at least a first of a plurality of subcarriers of the PDM-OFDM signal.

2. The method of optical communication in claim 1 further comprising
decoding a symbol for at least the first subcarrier based on the estimated channel matrix for the at least first subcarrier.

3. The method of optical communication in claim 1 further comprising
performing channel compensation based on the estimated channel matrix for the at least first subcarrier of the PDM-OFDM signal.

4. The method of optical communication in claim 3 wherein performing channel compensation comprises
inverting the estimated channel matrix; and
multiplying the inverted matrix with the received subcarrier vector for at least the first subcarrier of the PDM-OFDM signal.

5. The method of optical communication in claim 1 wherein the power of each training symbol is substantially the same as the power of a PDM-OFDM payload symbol such that the OFMD symbol sequence has a substantially constant-power format.

6. The method of optical communication in claim 1 further comprising
performing channel estimation to obtain an estimated channel matrix for each of the plurality of subcarriers of the PDM-OFDM signal;
performing channel compensation on a per subcarrier basis based on a corresponding estimated channel matrix.

7. The method of optical communication in claim 1 wherein a pair of training symbols are received periodically in the PDM-OFDM signal.

8. The method of optical communication in claim 1 wherein a same pair of training symbols are received periodically in the PDM-OFDM signal.

9. The method of optical communication in claim 1 wherein the pair of dual-polarization training symbols are correlated.

10. The method of optical communication in claim 9 wherein the pair of training symbols, denoted as t₁ and t₂, are correlated in the following way
$${t}_{1} = [ \begin{matrix}{t}_{x} \\ {t}_{y}\end{matrix} ] , \\ {t}_{2} = [ \begin{matrix}{t}_{x} \\ - {t}_{y}\end{matrix} ] ,$$
where tₓ and t_{y} are two known single-polarization symbols.

11. The method of optical communication in claim 9 wherein the received correlated pair of training symbols, denoted as
$${t}_{1}^{′} ( k ) = [ \begin{matrix}{t}_{1 x}^{′} ( k ) \\ {t}_{1 y}^{′} ( k )\end{matrix} ] , \\ {t}_{2}^{′} ( k ) = [ \begin{matrix}{t}_{2 x}^{′} ( k ) \\ {t}_{2 y}^{′} ( k )\end{matrix} ] ,$$
are jointly processed to obtain the estimated channel matrix for the k-th subcarrier as follows,
$$[ \begin{matrix}a ( k ) & b ( k ) \\ c ( k ) & d ( k )\end{matrix} ] = [ \begin{matrix}\frac{{t}_{1 x}^{′} ( k ) + {t}_{2 x}^{′} ( k )}{2 {t}_{x} ( k )} & \frac{{t}_{1 x}^{′} ( k ) - {t}_{2 x}^{′} ( k )}{2 {t}_{y} ( k )} \\ \frac{{t}_{1 y}^{′} ( k ) + {t}_{2 y}^{′} ( k )}{2 {t}_{x} ( k )} & \frac{{t}_{1 y}^{′} ( k ) - {t}_{2 y}^{′} ( k )}{2 {t}_{y} ( k )}\end{matrix} ] .$$

12. The method of optical communication in claim 9 wherein the optical field of each of two polarizations of each of the training symbols has a real and an imaginary component.

13. The method of optical communication in claim 9 wherein optical power waveform of each of two polarizations of each of the training symbols has a low peak-to-average-power ratio (PAPR).

14. The method of optical communication in claim 1 wherein performing channel estimation comprises:
determining a functional relationship between the received pair of dual-polarization training symbols and a transmitted pair of dual-polarization training symbols.

15. The method of optical communication in claim 1 further comprising
performing electronic dispersion compensation (EDC) on the received pair of training symbols.

16. An optical communication system comprising:
a polarization-division multiplexed (PDM) orthogonal frequency-division multiplexed (OFDM) transmitter, the transmitter including a training symbol insertion module for inserting a pair of dual-polarization or polarization-multiplexed training symbols into the OFDM symbol sequence; and
an OFDM receiver, the receiver comprising
a receiver front-end for receiving the pair of dual-polarization or polarization-multiplexed training symbols in the PDM-OFDM symbol sequence; and
a channel estimation module for performing channel estimation based on the pair of dual-polarization training symbols to obtain an estimated channel matrix for at least a first of a plurality of subcarriers of the PDM-OFDM signal.

17. The optical communication system of claim 16 wherein the receiver further comprises
a channel compensation module for performing channel compensation based on the estimated channel matrix for at least the first subcarrier of the PDM-OFDM signal.

18. The optical communication system of claim 17 wherein the receiver further comprises
a decoding module for decoding a symbol for at least the first subcarrier of the PDM-OFDM signal that has passed though the channel compensation module.

19. The optical communication system of claim 16 wherein the pair of dual-polarization training symbols are correlated.

20. The optical communication system of claim 16 further comprising:
a wavelength-division multiplexing (WDM) means that multiplexes multiple polarization-division multiplexed (PDM) orthogonal frequency-division multiplexed (OFDM) wavelength channels in the same system.
